(19) United States
(12) Patent Application Publication
(10) Pub. No.: US 2023/0352649 A1
(43) Pub. Date: Nov. 2, 2023

(54) REGENERATING LEAD ACID BATTERIES

(71) Applicant: THE BOARD OF TRUSTEES OF THE UNIVERSITY OF ILLINOIS, URBANA, IL (US)

(72) Inventors: Huimin Zhao, Urbana, IL (US); Zachary Gossage, Urbana, IL (US); Fang Guo, Urbana, IL (US); Kendrich Hatfeld, Urbana, IL (US); Teresa Martin, Urbana, IL (US); Quqi Tian, Urbana, IL (US); Elizabeth Gao, Urbana, IL (US); Ashok Kumar, Urbana, IL (US); Joaquín Rodríguez-López, Urbana, IL (US)

(21) Appl. No.: 18/308,522

(22) Filed: Apr. 27, 2023

Related U.S. Application Data
(60) Provisional application No. 63/335,595, filed on Apr. 27, 2022.

(51) Int. Cl. H01M 4/04; H01M 10/42; C25D 3/36; C25D 7/00; H01M 4/22

(52) U.S. Cl. CPC H01M 4/0452; H01M 10/4242; C25D 3/36; C25D 7/00; H01M 4/22

(57) ABSTRACT

Methods for removing sulfate from a battery electrode, methods for refurbishing batteries, methods of depositing a film on a battery electrode, and refurbished batteries are described. Methods for removing sulfate from a batter electrode include placing the battery electrode in a chelate solution to solubilize the sulfate and remove sulfate deposits from the battery electrode. Methods further include performing electrodeposition of a metal film on a battery electrode using chelate-metal solution resulting from the soaking process.

### CROSS REFERENCE TO RELATED APPLICATIONS

This application claims the benefit of the filing date of U.S. Provisional Application No. 63/335,595, filed on Apr. 27, 2022, entitled REGENERATING LEAD ACID BATTERIES. The entirety of the foregoing is hereby incorporated by reference.

### STATEMENT REGARDING FEDERALLY SPONSORED RESEARCH OR DEVELOPMENT

This invention was made with government support under grant numbers W9132T-15-2-0014, W9132T-17-2-0015, and W9132T-18-2-0004 awarded by the U.S. Department of Defense/DARPA. The United States Government has certain rights in the invention.

### FIELD OF THE INVENTION

This invention relates generally to the field of recycling and maintenance of batteries and more particularly to the field of desulfation of spent lead acid batteries.

### BACKGROUND

Lead-acid batteries (LABs) are the lowest cost and most used secondary battery worldwide with expected market growth to continue alongside the developing automobile industry. In spite of their commercial success, LABs have relatively short cycle lifetimes compared to lithium ion batteries and produce extensive waste per year (2.46 million tons in 2014). As such, the need for understanding, preventing and remediating LAB failure modes, and for extending battery lifetime is becoming more significant.

One major cause of failure in LABs is hard sulfation. This occurs when LABs are operated under partial state of charge, cycled at high rates, deeply discharged, or stored in their discharged state. Lead (II) sulfate (PbSO₄) formation occurs on both electrodes as part of the energy storage mechanism, but hard sulfation occurs when the PbSO₄ crystals at the negative electrode become too large for effective reduction and impede access to the batteries original capacity. Accumulation of PbSO₄ reduces the effective reaction area, increases cell resistance and eventually leads to failure of the battery.

Researchers have directed their attention toward preventing hard sulfation and improving cycle life through additives to the bulk of the negative electrodes active material, electrolyte, and unique charging protocols. These methods may improve the overall performance and lifetime of the LAB, but primarily only apply to new or partially sulfated batteries. Heavily sulfated LABs are still recycled after they fail at effectively storing or outputting charge.

Typically, the goal of recycling is to separate the battery components and reconstitute them for further applications. Interestingly, significantly less effort has been directed toward development in situ refurbishing or recycling technologies even though it eliminates the disassembly/reassembly process and could minimize waste output. Therefore, there is a need to develop an efficient method of in situ refurbishing for hard sulfated LABs in order adequately recycle these batteries.

### SUMMARY

Embodiments of the present disclosure include methods for removing sulfate from a battery electrode, methods for refurbishing batteries, methods of depositing a film on a battery electrode, and refurbished batteries. In certain embodiments, methods for removing sulfate from a batter electrode include placing the battery electrode in a chelate solution to solubilize the sulfate and remove sulfate deposits from the battery electrode. In certain embodiments, methods further include performing electrodeposition of a metal film on a battery electrode using chelate-metal solution resulting from the soaking process.

These and other features, objects and advantages of the present disclosure will become better understood from the description that follows. In the description, reference is made to the accompanying drawings, which form a part hereof and in which there is shown by way of illustration, not limitation, embodiments of the disclosure.

### BRIEF DESCRIPTION OF THE DRAWINGS

The features, objects and advantages other than those set forth above will become more readily apparent when consideration is given to the detailed description below. Such detailed description makes reference to the following drawings, wherein:

FIG. 1 shows removal of PbSO₄ from negative electrodes with EDTA in accordance with an embodiment of the present disclosure. A) Optical microscopy of heavily sulfated electrodes (US6TMF). B) SEM image of same electrode after soaking in a 100 mM EDTA solution at pH 10 for 24 hours. C) Optical profilometry of unused negative electrodes (Yuasa) after soaking half the electrode in 100 mM EDTA at pH 6.3 (C) and 4.1 (D) for approximately 12 hours.

FIG. 2 shows electrode surface restructuring during EDTA treatment in accordance with an embodiment of the present disclosure. A) XRD before and after treatment in a 100 mM EDTA solution at pH 10 for 24 hours. Peaks for PbSO₄ and Pb are identified with markers. B) Illustration of the surface reshaping process and its impact on sulfate reduction after interacting with EDTA.

FIG. 3 shows analysis of pH impact on Pb-EDTA electrolysis in accordance with an embodiment of the present disclosure. A) Top view of Pt UME before Hg deposition. Hg deposited on the Pt UME; top view (B) and side-view (C). D) Illustration showing voltammetry at a HgUME during amalgam formation and stripping. E) Amalgam-stripping voltammetry at a Hg probe with EDTA and PbSO₄ at different pH values compared with Pb(NO₃)₂. All solutions contained 100 mM NaSO₄ for supporting electrolyte. The pH was adjusted using H₂SO₄ and NaOH.

FIG. 4 shows Pb electrodeposition on Au macro disc from Pb-EDTA in accordance with an embodiment of the present disclosure. A) Diagram of Pb film growth on Au electrode. B) Au electrode (radius=1 mm) before (left) and after (right) Pb electrodeposition at −2 V vs. Hg/HgSO₄·C) The i-t response during the electrodeposition process. The deposition solution consisted of 5 mM PbSO₄, 10 mM EDTA, and 100 mM Na₂SO₄ at pH 4.65. Microscopy (D) and optical profilometry (E) of a Pb film electrodeposited on Au at −1.3 V vs. Hg/HgSO₄ for 2 hours using 20 mM PbSO₄, 40 mM EDTA, 100 mM Na₂SO₄, at pH 3. The arrow in (D) shows the path of the optical profilometry of the film.

FIG. 5 (7) shows a multistep electrochemical process for in situ refurbishing for LABs in accordance with an embodiment of the present disclosure.

FIG. 6 shows a multistep process for in situ refurbishing for LABs where treatment with an ammonium salt (carbonate) and then a strong acid occurs.

FIG. 7 shows a multistep process for in situ refurbishing for LABs where treatment with an ammonium salt (carbonate) and then a strong acid occurs.

FIG. 8 shows a multistep process for in situ refurbishing for LABs where treatment with an ammonium salt (phosphate) and then a strong acid occurs.

FIG. 9 shows a multistep process for in situ refurbishing for LABs where treatment with an ammonium salt (carbonate) and then a weak acid solution occurs.

FIG. 10 shows a multistep process for in situ refurbishing for LABs where treatment with the ammonium salt of a weak acid such as ammonium formate, ammonium acetate, or ammonium tartrate occurs.

While the present disclosure is susceptible to various modifications and alternative forms, exemplary embodiments thereof are shown by way of example in the drawings and are herein described in detail. It should be understood, however, that the description of exemplary embodiments is not intended to limit the disclosure to the particular forms disclosed, but on the contrary, the intention is to cover all modifications, equivalents and alternatives falling within the spirit and scope of the disclosure.

The features, objects and advantages other than those set forth above will become more readily apparent when consideration is given to the detailed description below. Such detailed description makes reference to the following drawings, wherein:

While the present disclosure is susceptible to various modifications and alternative forms, exemplary embodiments thereof are shown by way of example in the drawings and are herein described in detail. It should be understood, however, that the description of exemplary embodiments is not intended to limit the disclosure to the particular forms disclosed, but on the contrary, the intention is to cover all modifications, equivalents and alternatives falling within the spirit and scope of the disclosure.

### DETAILED DESCRIPTION OF PREFERRED EMBODIMENTS

The technology will now be described more fully hereinafter with reference to the accompanying drawings, in which some, but not all embodiments of the invention are shown. Indeed, the technology may be embodied in many different forms and should not be construed as limited to the embodiments set forth herein; rather, these embodiments are provided so that this disclosure will satisfy applicable legal requirements.

Likewise many modifications and other embodiments of the technology described herein will come to mind to one of skill in the art to which the invention pertains having the benefit of the teachings presented in the foregoing descriptions and the associated figures. Therefore, it is to be understood that the technology is not to be limited to the specific embodiments disclosed and that modifications and other embodiments are intended to be included within the scope of the appended claims. Although specific terms are employed herein, they are used in a generic and descriptive sense only and not for purposes of limitation.

The technology disclosed herein include chelators used in a process involving: 1) the removal of sulfates (e.g. large inactive PbSO₄ crystals) to reactivate damages electrodes and 2) electrodeposition of fresh electrode material from the metal chelator solution. Certain aspects of the present disclosure utilize material characterization and electrochemical methods for in situ refurbishing for sulfated batteries (e.g. hard sulfated LABs). Although the disclosure focuses on the negative electrode because it is the most susceptible to irreversible PbSO₄ deposits, the present technology is not limited to the negative electrode of a battery.

Certain embodiments of the present disclosure are advantageous in that an in situ protocol is provided that extends the life of a battery (e.g. LAB) without disassembly or extensive material processing. This reduces the waste produced by hard-sulfation of LAB as well as increases the lifetime and productivity of LABs.

### Overview

Embodiments of the present disclosure include methods for removing sulfate (e.g., hard sulfate) deposits on a battery electrode (e.g., the negative electrode) while maintaining their electrochemical viability for subsequent electrodeposition into active electrode material (e.g., Pb). Embodiments of the present disclosure include soaking the electrode (e.g., hard sulfate negative electrode) in a solution (e.g., an ammonium salt solution) to reshape the surface by solubilizing PbSO₄ to PbCO₃, Pb₃(PO₄)₂, or PbA₂ while avoiding underlying Pb phases. In certain embodiments, thereafter, treatment with a strong acid is then performed. In other certain embodiments, treatment with a weak acid solution is performed after treatment with a ammonium salt solution. Other certain embodiments include soaking the electrode (e.g., hard sulfate negative electrode) in a solution (e.g., an alkaline EDTA solution) to reshape the surface by solubilizing PbSO₄ to Pb-EDTA while avoiding underlying Pb phases. In certain embodiments, thereafter, electrodeposition (e.g., electrodeposition of lead from PbEDTA, PbSO₄ to PbCO₃, Pb₃(PO₄)₂, or PbA₂) is performed.

### EDTA as Chelator Agent:

EDTA is a strong, tetradentate chelating molecule often used in quantitative analysis due to the 1:1 complexes it forms with metal ions in solution. EDTA is known for its strong chelation to various metal ions including Pb²⁺ with a large formation constant, K, of 10. EDTA can enhance solubilization of lead salts including PbSO₄, but efforts to control or understand PbSO₄-chelator interactions for use in combatting hard sulfation to extend the life of LAB technologies are not present.

In solution, EDTA is found as a distribution of species with different levels of protonation, e.g. H₄EDTA, H₃EDTA⁻, etc. At low pH, as in LABs, EDTA can become fully protonated (H₄EDTA) and tends to precipitate. As such, the level of protonation impacts chelation to other ions in solution through the conditional K, or K′ as described by:

K′=α_{Y}⁴⁻K

where α represents the fraction of EDTA in one of the protonated forms, and Yⁿ⁻ designates the charge and form with n number of unprotonated groups. By changing the pH, the distribution of protonated species and K′ change, because fewer coordinating groups are available for binding. In aspects of the present disclosure, pH is utilized as a controlling parameter for driving removal of hard sulfates at the negative LAB electrodes, while simultaneously allowing the facile electrodeposition of the chelated material to restore the negative electrode.

Chelators improve PbSO₄ solubility by forming a complex with Pb²⁺ which can be reversibly reduced to redeposit Pb metal. Reduction of the Pb-EDTA chelates can form uniform metal films and the EDTA molecules can be reused for further binding. However, these films are generally not tested as a battery material.

### Ammonium Salts as Chelator Agent:

It has also been shown that include methods for clearing electrodes (e.g., Pb negative electrodes) from sulfate deposits (e.g., hard sulfate deposits) via a chelation procedure may be done using various ammonium salts. Methods involving treatment with an ammonium salt as the chelating agent along with treatment with a strong acid solution. Methods involving treatment with an ammonium salt (e.g., ammonium carbonate) also may include treatment with a weak acid. Electrodeposition of the lead battery can then be carried out. Using ammonium salt solutions paired with a weak acid treatment results in Pb Nitrate as the intermediate. Positives of Pb nitrate are the high solubility in nitrate form as well as greater packing density in electrodeposition.

### EXAMPLES

### EDTA Example(s)

Ethylenediaminetetraacetic acid, disodium dihydrate salt (EDTA (Fisher, >99%)) and nitrilotriacetic acid (NTA (Sigma Aldrich, >99%)) were used without further purification as chelators. Lead sulfate (PbSO₄ (Acro Organics, 99%) and lead nitrate (Pb(NO₃)₂ (Fisher, >99%)) were used as lead salts. Sulfuric acid (H₂SO₄, Macron) and sodium hydroxide (NaOH (Fisher, >99%)) were used for adjusting pH. We used potassium nitrate (KNO₃ (Fisher, >99%)) and sodium sulfate (Na₂SO₄ (Sigma Aldrich, >99%)) as additional supporting electrolytes. Hg probes were prepared with Hg nitrate (Hg(NO₃)₂ (Sigma Aldrich, >99.99%)) as described previously. The Au electrodes were either commercial metal disc electrodes or Au coated onto a silicon substrate with a Temescal electron-beam evaporator. Commercial 6 V lead acid batteries (LABs) were purchased from Yuasa with 5.5 Ah (model—YUAM2655B 6N5.5-1D). All electrolyte solutions were prepared in HPLC grade water (Macron).

Removing Lead Sulfates from Electrodes Via Chelation Therapy

Damaged flooded lead acid batteries (US6TMF, 12 V) were received from the U.S. Army after battery failure. The electrolyte was removed and the inside chamber was neutralized with a sodium hydroxide solution (Caution: residual sulfuric acid is caustic, contains lead, and should be handled with extreme care!). The plastic container was disassembled, and the negative electrodes were collected. The electrode plates were then dried and stored under ambient conditions until further use. To evaluate hard sulfate removal through chelation, the electrode plates were cut into small pieces and soaked in either: 1) 100 mM EDTA, 2) 100 mM NTA, or 3) water with no chelator. The pH of each soaking solution was adjusted using H₂SO₄ or NaOH. Thereafter, the electrodes were washed with DI water and stored until further measurements. The electrodes were characterized before and after treatment with microscopy and X ray powder diffraction (XRD). For optical and scanning electron microscopy, we utilized a Zeiss and Hitachi 54700 SEM, respectively. For XRD, we used a Rigaku MiniFlex 600 in reflection mode for 2θ between 10° and 100°. Peaks were compared with literature values.

Electrodes from new flooded lead acid batteries were also investigated for chelation treatment. The LABs were purchased from Yuasa and disassembled before cycling. After cutting the negative electrodes into smaller pieces, half of each electrode was soaked in 100 mM EDTA at different pH values. After 12 hours of soaking, the electrodes were rinsed with water, dried ambiently and characterized using optical profilometry (Keyence VK-X1000 3D laser scanning confocal microscope).

Electrodeposition of Pb from Pb-Chelator Complexes

All electrochemical measurements were performed using either a CHI760 or a CHI660 potentiostat. Hg-based ultramicroelectrodes (UMEs) were prepared as described previously. A 25 μm Pt wire (Goodfellow, 99.9% purity) was sealed in borosilicate glass, sharpened with sandpaper and polished with alumina powder (1 inn) to a flat microdisc. Next, a Hg hemisphere was electrochemically deposited on top of the Pt surface by applying a reducing potential at the Pt UME in a 5 mM Hg(NO₃)₂ solution with 100 mM KNO₃ supporting electrolyte. Solutions of PbSO₄, EDTA, and Na₂SO₄ were prepared at different pH (adjusted with NaOH or H₂SO₄). A tungsten wire counter electrode was used, and either a standard calomel electrode, or Hg/HgSO₄ as the reference electrode was used. For simplicity, all potentials were adjusted to Hg/HgSO₄. Cyclic voltammetry at the HgUME to measure Pb-EDTA reduction and Pb stripping was used. All solutions were bubbled for 10 minutes with Ar to remove oxygen and then adjusted to form an Ar blanket above the solution. To evaluate electrodeposition of Pb films from Pb-EDTA, Au disk electrodes (radius=1 mm) and unused negative electrodes from the Yuasa battery were used. Potentiostatic and galvanostatic methods were applied to deposit films under ambient conditions. The films were analyzed with microscopy, optical profilometry, and SEM.

Testing of Pb Deposits as Negative Electrode Material

After electrodepositing Pb films, the electrodes were rinsed with fresh water and the cell was refilled with 4.2 M H₂SO₄. The deposited films were cycled using cyclic voltammetry or constant current galvanostatic charge/discharge. Their cycling behavior was compared with a commercial LAB (Yuasa). The commercial LAB was cycled using a BT-I battery cycler from Arbin Instruments. After deeply discharging the LAB, it was fully charged using a constant potential of 6.2 V (for three cells in series). Thereafter, it was cycled using a protocol of 500 mA discharge rate (˜0.1 C) to 4 V, and 20 mA charge rate (˜0.005 C) to 6.4 V. The battery was stopped after thirty charge/discharge cycles.

Interactions Between Chelators and Sulfates on Battery Electrodes

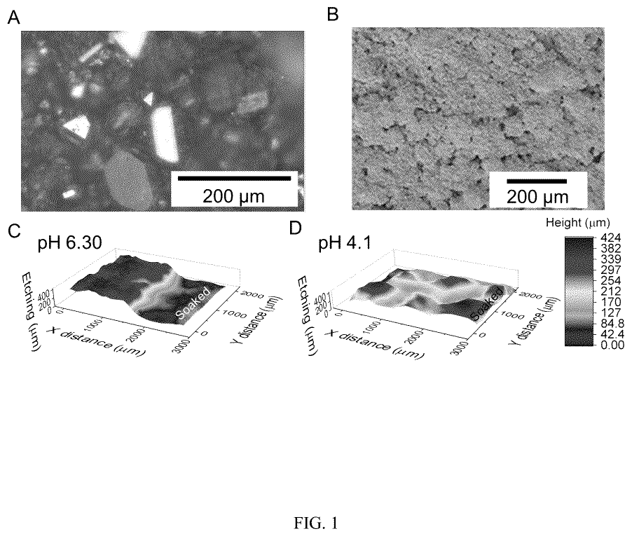

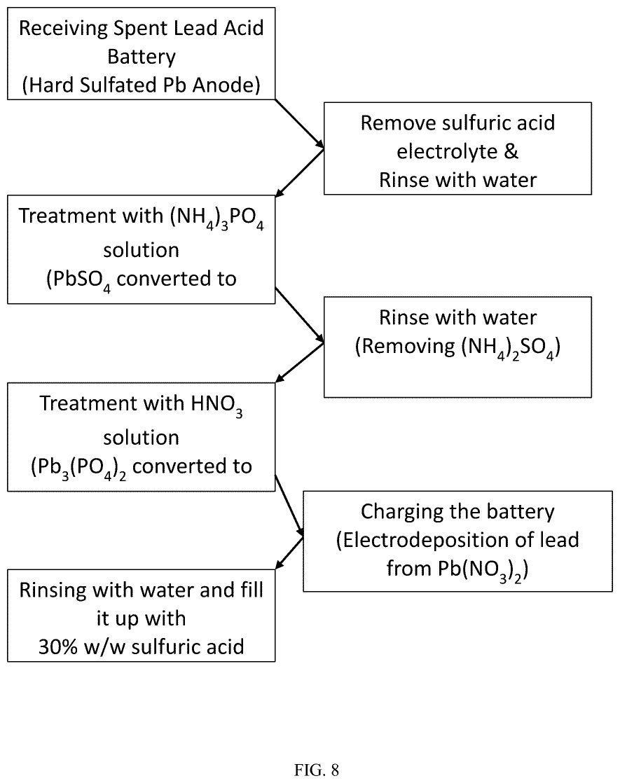

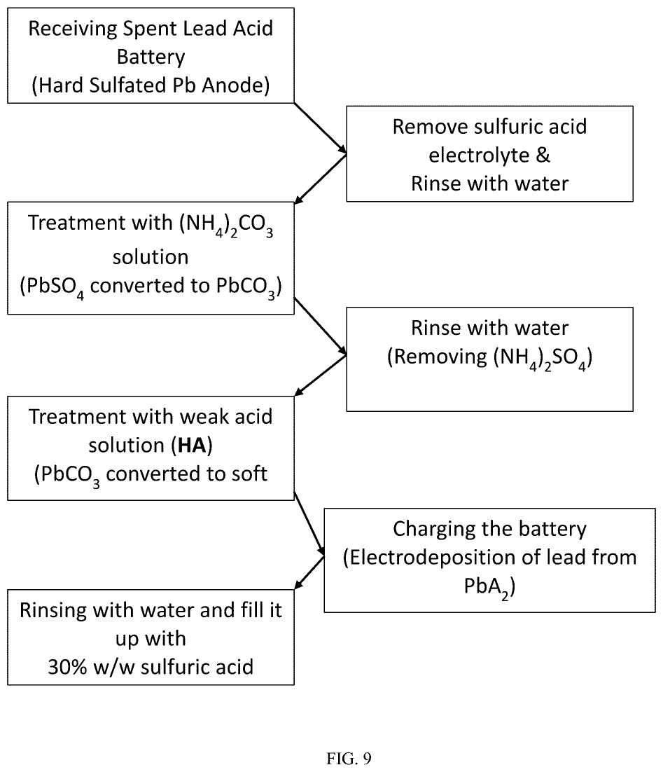

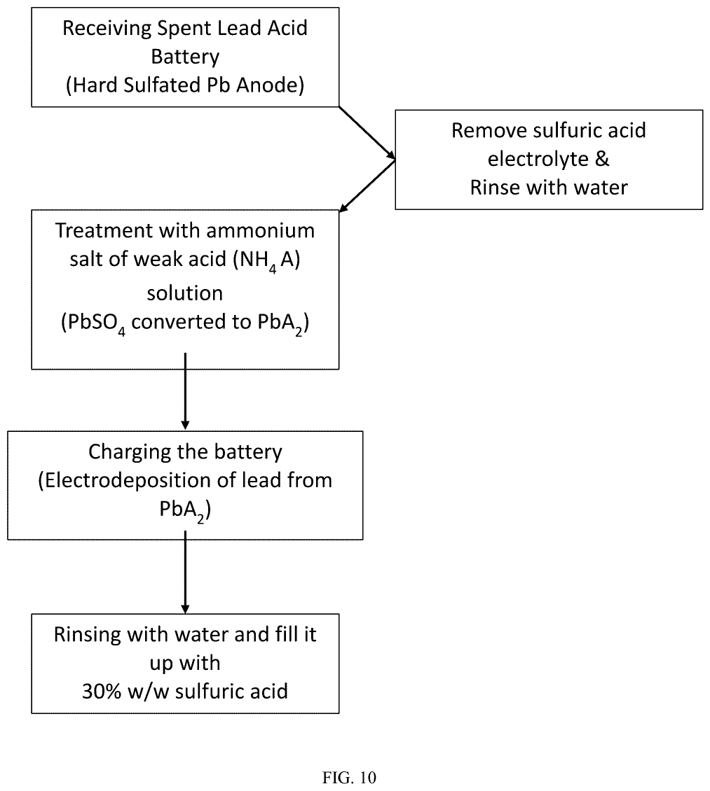

First, removal of PbSO₄ crystals from negative electrode surfaces was evaluated by immersing and soaking the electrodes in chelator solutions. Electrodes harvested from underperforming commercial flooded LABs (US6TMF) showed extensive coverage by large PbSO₄ crystals of various sizes (20-100 μm) as seen in FIG. 1A. Portions of these electrodes were placed into chelator solutions with varied effective formation constants, K′, to determine the impact of the chelator species on PbSO₄ dissolution. Under high K′, such as soaking the electrodes in a pH 10 solution containing 100 mM EDTA, it was found that the large crystals were roughened and/or completely removed after 24 hours without agitation (FIG. 1B). When lowering the EDTA solution pH to acidic conditions (below pH 3), we observed significant EDTA precipitation and only partial removal of the PbSO₄ crystals (FIG. 8). Considering the impact of pH on α_{Y}⁴⁻, α_{Y}³⁻, etc., the available binding forms of EDTA diminish dramatically below pH 4. Similar poor reactivity was found when using other chelators with a lower K′, including NTA, even after soaking for 7 days (FIG. 8). EDTA was also evaluated on commercial electrodes that were not previously cycled (Yuasa, 6.5 Ah) with small, sub-micron sized crystals across their surfaces (FIG. 9). Half of each electrode was dipped in an EDTA solution and soaked for 12 hours (FIG. 1C,D). Again, strong Pb-EDTA binding conditions led to uniform material removal (FIG. 1C), while lowering the pH (FIG. 1D) or removing the chelator (FIG. 10) diminished the removal process. In total, manipulation of pH and K′ can help control sulfate removal to make it more rapid or gradual depending on the severity of sulfation.

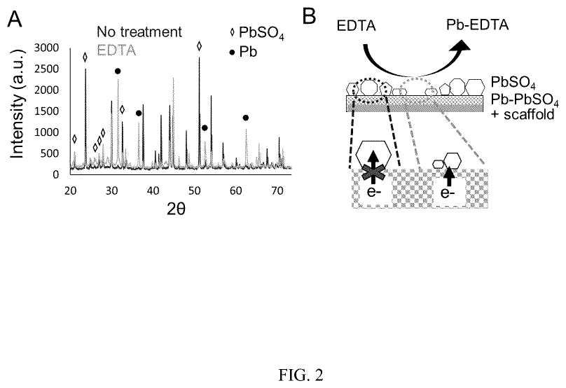

To further investigate the surface reconstruction process, x-ray diffraction (XRD) was utilized before and after treatment (FIG. 2A). After EDTA treatment, multiple peaks associated with PbSO₄ (2Θ=24, 33, and 52) decreased in intensity, and peaks associated with Pb phases (2Θ=32, 37, 53, 63) increased. The XRD results indicate that EDTA preferentially attacked PbSO₄, while leaving Pb metal phases unperturbed. The inertness of the EDTA solution with metallic Pb was verified by soaking a piece of Pb metal (37 mg) in excess EDTA (1:10 for Pb:EDTA) at pH 10 for 14 days. The piece remained intact without any apparent dissolution and only 5% mass loss. The enhancement of PbSO₄ solubilization by EDTA apparently relies upon interaction with the ionic form of Pb, e.g. Pb²⁺, which was not readily present at the surface of Pb metal. Taking into consideration the 3D nature of LAB electrodes, targeted removal of inert PbSO₄ species at the surface could reveal an underlying layer of metallic Pb that is more reactive and conductive (FIG. 2B). By making electron transfer sites more accessible, the remaining sulfate crystals would be more readily reduced back to Pb (FIG. 2B), thereby restoring some of the electrode's original capacity. However, this removal process places much of the Pb content, and thus the battery's original capacity, into a solubilized chelate. To put the chelated material back in service at the negative electrode, a two-step process was conducted, involving: 1) sulfate removal to reactivate the electrode surface, then 2) using the reactivated electrode to reduce Pb-EDTA directly and redeposit fresh, active electrode material.

Electrodeposition of Pb Films from Pb-Chelator Complexes

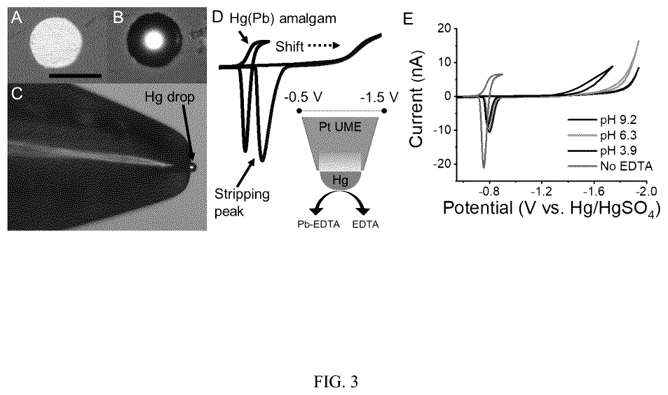

In this section, electrodeposition of fresh active electrode material from electrochemical reduction of Pb-EDTA solutions was conducted. Such a process may involve the growth of high purity Pb films through electrolysis of Pb-EDTA, and reusing the EDTA molecules for further chelation reactions. Amalgam/stripping voltammetry at Hg-based microelectrodes (HgUME) (FIG. 3A-C) was utilized. HgUMEs are powerful analytical tools for evaluating metal cations in battery systems, and can provide quantitative measurements based on analysis of the stripping peaks. As the HgUMEs potential is swept negative, Hg can form highly concentrated, reversible amalgams through reduction of the metal cations or their chelates (FIG. 3D). As shown in FIG. 3E, EDTA chelation led to a large negative shift, >400 mV, for forming the Pb—Hg amalgam compared to the ionic salt, Pb(NO₃)₂. Therefore, binding to the EDTA inhibited Pb²⁺ reduction, requiring greater overpotentials. Increasing the pH of the Pb-EDTA solution induced negative potential shifts for the Pb—Hg amalgamation process as previously reported on other electrodes. When EDTA was in solution, a defined forward cathodic wave under acidic conditions was only observed. When the pH was very high, the cathodic wave was not resolved due to overlapping solvent processes. However, Pb deposition remained substantial as all the stripping peaks—indicative of redissolution of the amalgamated Pb— were comparable in total charge. The results agreed that the required overpotential to reduce the Pb-chelator species decreased along with pH and K′. From these results, focus was turned toward low pH conditions for further experiments, as this also represents a condition that is more energetically favorable towards an ultimate objective of refurbishing a battery.

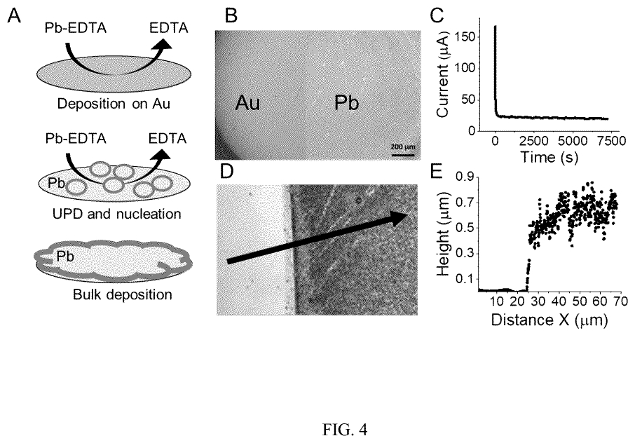

To evaluate Pb film growth, Au electrodes (FIG. 4A) were utilized, because Au is visibly distinguishable from Pb, and Au electrodes provide observable stripping peaks (FIG. 12) for determining deposition potentials. On Au, Pb initially deposits as a sub-monolayer during underpotential deposition before forming bulk films (FIG. 4A). As seen in FIG. 4B, electrodeposition of Pb from Pb-EDTA formed a uniform film across the gold electrode when electrodepositing at a constant potential (FIG. 4C). After deposition, the open circuit potentials shifted to more negative potentials (FIG. 13) indicating good coverage of Pb on the underlying Au surface. Further, promising results were obtained when depositing films while applying a constant current, 57 μA/cm² in 5 mM PbSO₄ for this case (FIG. 13). The impact of Pb-EDTA concentration on film thickness was evaluated by performing a series of experiments with increasing concentrations of Pb-EDTA. An increase in Pb film thickness from ˜200 nm to greater than 1 μm with increasing Pb-EDTA using a 2 hour deposition time at ˜1.3 V vs. Hg/HgSO₄ was observed (FIG. D, E, 14). The films consisted of densely packed crystallites without any optimization of the deposition process (FIG. 15). Nevertheless, film characteristics can be manipulated in various ways either through variation of the chemical precursors or the electrochemical procedure, emphasizing the vast potential of using an electrochemical procedure in tandem with a removal process to grow fresh electrode material.

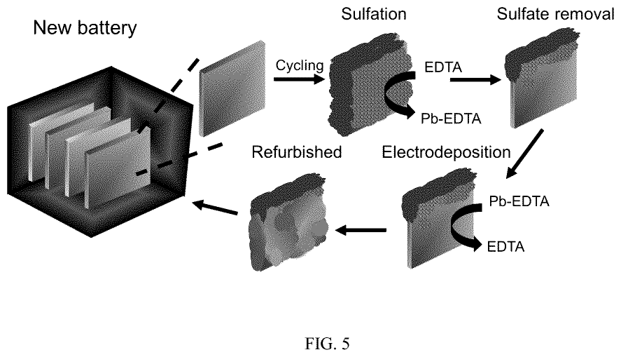

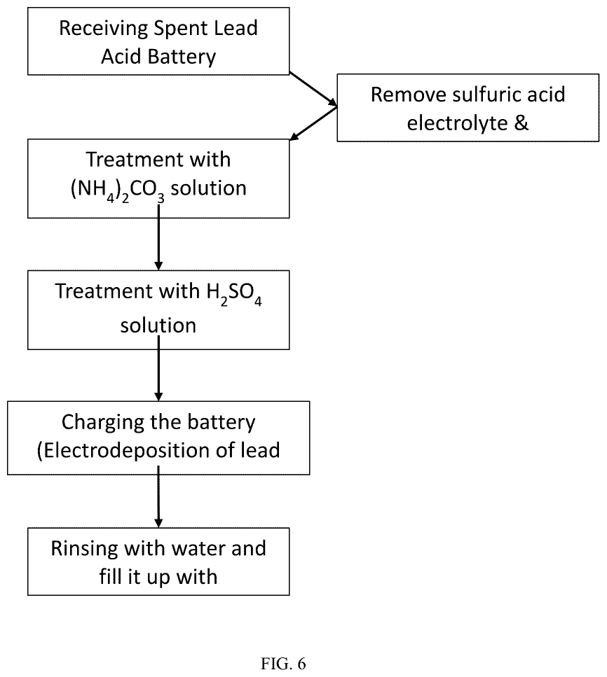

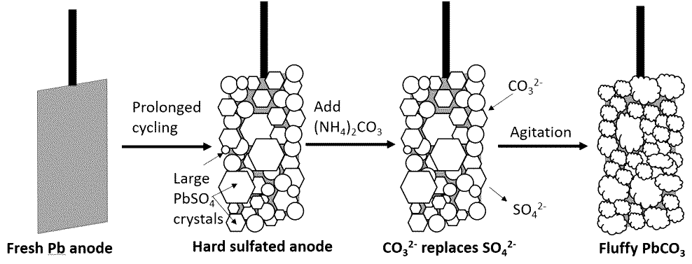

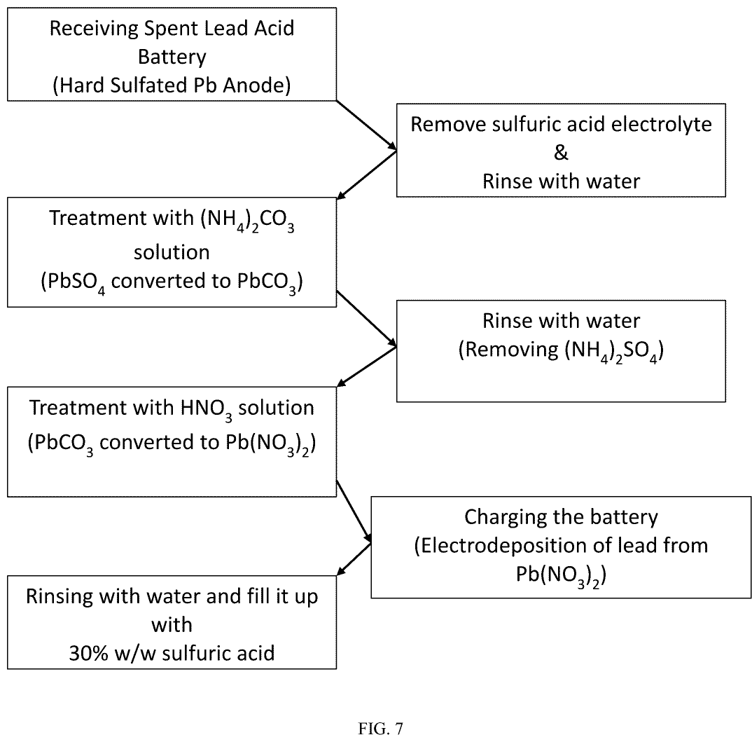

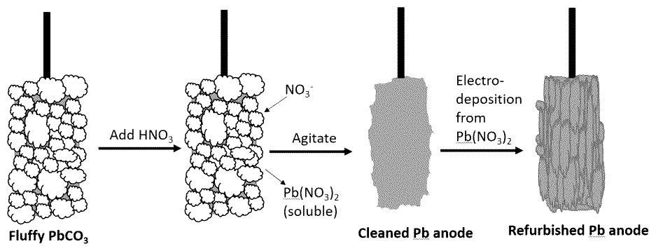

After confirming the deposition process, electrodeposition of Pb films directly onto negative electrodes from a commercial, flooded LAB (Yuasa) was examined. Others have explored Pb film electrodeposition onto different electrode materials including Pb, Cu, steel, and Pt, but not onto the real negative electrodes found inside LABs. A fresh negative electrode was submerged into a solution containing 20 mM PbSO₄ solution with 40 mM EDTA at pH 3. The Pb film was grown at a constant current of 50 mA for 15 hours, and then the electrode was rinsed with water/ethanol and allowed to dry. Thereafter, the deposited film was compared with the original electrode material (FIG. 5). In this case, the film showed a morphology with larger, flatter Pb deposits (FIG. 5B) compared to the commercial active material (FIG. 5D). Realizing that negative electrodes are capable of further electrodeposition is a promising result, because that alone could be used as a strategy for further enhancing the capacity of the LAB or for utilizing alternative deposition chemistries.

### Ammonium Salt Example(s)

(1): Spent lead battery is received with hard sulfate (PbSO₄) deposits present on negative electrode. The sulfuric acid electrolyte is removed and rinsed with water. Treatment with ammonium carbonate converts PbSO₄ in PbCO₃. LAB is then treated with H₂SO₄ solution to convert PbCO₃ to soft PbSO₄. Charging of the battery then occurs (Electrodeposition of lead from PbSO₄). Rinsing with water and filled with 30% w/w sulfuric acid electrolyte.

(2): Spent lead battery is received with hard sulfate (PbSO₄) deposits present on negative electrode. The sulfuric acid electrolyte is removed and rinsed with water. Treatment with ammonium carbonate converts PbSO₄ in PbCO₃. LAB is then rinsed with water to remove the (NH₄)₂SO₄. Treatment with HNO₃ to convert PbCO₃ to Pb(NO₃)₂). Charging of the battery then occurs (Electrodeposition of lead from Pb(NO₃)₂). Rinsing with water and filled with 30% w/w sulfuric acid electrolyte.

(3): Spent lead battery is received with hard sulfate (PbSO₄) deposits present on negative electrode. The sulfuric acid electrolyte is removed and rinsed with water. Treatment with ammonium phosphate solution converts PbSO₄ to Pb₃(PO₄)₂. Rinse with water to remove (NH₄)₂SO₄. Treatment with HNO₃ to convert (Pb₃(PO₄)₂ to Pb(NO₃)₂). Charging of battery then occurs (Electrodeposition of lead from Pb(NO₃)₂). Rinsing with water and filled with 30% w/w sulfuric acid electrolyte.

(4): Spent lead battery is received with hard sulfate (PbSO₄) deposits present on negative electrode. The sulfuric acid electrolyte is removed and rinsed with water. Treatment with (NH₄)₂CO₃ solution (PbSO₄ converted to PbCO₃). Rinse with water (Removing (NH₄)₂SO₄). Treatment with weak acid solution (HA) (PbCO₃ converted to soft PbA₂). Charging the battery (Electrodeposition of lead from PbA₂). Rinsing with water and fill it up with 30% w/w sulfuric acid electrolyte.

(5): Spent lead battery is received with hard sulfate (PbSO₄) deposits present on negative electrode. The sulfuric acid electrolyte is removed and rinsed with water. Treatment with ammonium salt of weak acid (NH₄A) solution. Charging the battery (electrodeposition of lead from PbA₂). Rinsing with water and fill it up with 30% w/w sulfuric acid electrolyte.

Embodiments of the present disclosure include refurbishing procedures, opening new directions for in situ recycling and life extension of LABs even after extreme sulfation or electrode damage. It can be understood that embodiments of the present disclosure may further include the design of strong chelators that incorporate desirable properties for operating at extreme pH and that optimize the overpotential needed for electrodeposition.

### REFERENCES

1. O. Schmidt, A. Hawkes, A. Gambhir, and I. Staffell, “The future cost of electrical energy storage based on experience rates.” Nat. Energy, 2(8), 17110 (2017).
2. Z. P. Cano, D. Banham, S. Ye, A. Hintennach, J. Lu, M. Fowler, and Z. Chen, “Batteries and fuel cells for emerging electric vehicle markets.” Nat. Energy, 3(4), 279 (2018).
3. X. Zhang, L. Li, E. Fan, Q. Xue, Y. Bian, F. Wu, and R. Chen, “Toward sustainable and systematic recycling of spent rechargeable batteries.” Chem. Soc. Rev., 47(19), 7239 (2018).
4. Z. Sun, H. Cao, X. Zhang, X. Lin, W. Zheng, G. Cao, Y. Sun, and Y. Zhang, “Spent lead-acid battery recycling in China-A review and sustainable analyses on mass flow of lead.” Waste Management, 64, 190 (2017).
5. W. Zhang, J. Yang, X. Wu, Y. Hu, W. Yu, J. Wang, J. Dong, M. Li, S. Liang, and J. Hu, “A critical review on secondary lead recycling technology and its prospect.” Renew. Sust. Energ. Rev., 61, 108 (2016).
6. H. A. Catherino, F. F. Feres, and F. Trinidad, “Sulfation in lead-acid batteries.” J. Power Sources, 129(1), 113 (2004).
7. R. Shapira, G. D. Nessim, T. Zimrin, and D. Aurbach, “Towards promising electrochemical technology for load leveling applications: extending cycle life of lead acid batteries by the use of carbon nano-tubes (CNTs).” Energy Environ. Sci., 6(2), 587 (2013).
8. Q. Long, G. Ma, Q. Xu, C. Ma, J. Nan, A. Li, and H. Chen, “Improving the cycle life of lead-acid batteries using three-dimensional reduced graphene oxide under the high-rate partial-state-of-charge condition.” J. Power Sources, 343, 188 (2017).
9. K. Liu, Q. Tan, L. Liu, and J. Li, “From lead paste to high-value nano-lead sulfide products: a new application of mechanochemistry in the recycling of spent lead-acid batteries.” ACS Sustain. Chem. Eng., 8(9), 3547 (2020).
10. D. Pavlov, Lead-acid batteries: science and technology. Elsevier, (2011).
11. P. T. Moseley, “Consequences of including carbon in the negative plates of Valve-regulated Lead-Acid batteries exposed to high-rate partial-state-of-charge operation.” J. Power Sources, 191(1), 134 (2009).
12. L. T. Lam, N. P. Haigh, C. G. Phyland, and A. J. Urban, “Failure mode of valve-regulated lead-acid batteries under high-rate partial-state-of-charge operation.” J. Power Sources, 133(1), 126 (2004).
13. X. Zou, Z. Kang, D. Shu, Y. Liao, Y. Gong, C. He, J. Hao, and Y. Zhong, “Effects of carbon additives on the performance of negative electrode of lead-carbon battery.” Electrochim. Acta, 151, 89 (2015).
14. N. Vangapally, S. A. Gaffoor, and S. K. Martha, “Na₂EDTA chelating agent as an electrolyte additive for high performance lead-acid batteries.” Electrochim. Acta, 258, 1493 (2017).
15. A. Banerjee, B. Ziv, Y. Shilina, E. Levi, S. Luski, and D. Aurbach, “Single-wall carbon nanotube doping in lead-acid batteries: a new horizon.” ACS Appl. Mater. Interfaces, 9(4), 3634 (2017).
16. J. Yin, Z. Lin, D. Liu, C. Wang, H. Lin, and W. Zhang, “Effect of polyvinyl alcohol/nano-carbon colloid on the electrochemical performance of negative plates of lead acid battery.” J. Electroanal. Chem., 832, 152 (2019).
17. G. Petkova, P. Nikolov, and D. Pavlov, “Influence of polymer additive on the performance of lead-acid battery negative plates.” J. Power Sources, 158(2), 841 (2006).
18. B. Zhang, J. Zhong, W. Li, Z. Dai, and Z. Cheng, “Transformation of inert PbSO₄ deposit on the negative electrode of a lead-acid battery into its active state.” J. Power Sources, 195 (13), 4338 (2010).
19. C. Spanos, S. A. Berlinger, A. Jayan, and A. C. West, “Inverse charging techniques for sulfation reversal in flooded lead-acid batteries.” J. Electrochem. Soc., 163(8), A1612 (2016).
20. A. Al Zyoud and W. A. Elhaija, “Solar power lead battery storage solution using cycle recovery charging method.” J. Energy Storage, 25, 100843 (2019).
21. S. Tan, D. J. Payne, J. P. Hallett, and G. H. Kelsall, “Developments in electrochemical processes for recycling lead-acid batteries.” Curr. Opin. Electrochem., 16, 83 (2019).
22. H. Karami and R. Asadi, “Recovery of discarded sulfated lead-acid batteries.” J. Power Sources, 191(1), 165 (2009).
23. M. Zeine, Electrolyte and sulfuric acid battery containing same., U.S. Pat. No. 9,819,055, (2017).
24. D. C. Harris, Quantitative chemical analysis. W. H. Freeman and Company, New York, (2016).
25. R. M. Smith, A. E. Martell, and R. J. Motekaitis, “NIST Critically Selected Stability Constants of Metal Complexes.” In NIST Standard Reference Database 46, Gaithersburg, MD, (2004).
26. C. Kim, Y Lee, and S. K. Ong, “Factors affecting EDTA extraction of lead from lead-contaminated soils.” Chemosphere, 51(9), 845-853 (2003).
27. H. E. Allen, and P. H. Chen, “Remediation of metal contaminated soil by EDTA incorporating electrochemical recovery of metal and EDTA.” Environ. Prog., 12(4), 284-293 (1993).
28. M. D. Capelato, N. M. Cassiano, and L. A. Ramos, “A practical application of the Pb/PbO₂ cell: the determination of the state of charge of lead-acid batteries.” J. Chem. Educ., 72(9), 845 (1995).
29. R. Belcher, D. Gibbons, and T. S. West, “The effect of ethylenediaminetetraacetic acid on the ferrous/ferric and cuprous/cupric redox systems.” Anal. Chim. Acta, 12, 107 (1955).
30. E. Juzeliunas, H. W. Pickering, and K. G. Weil, “Electrochemical quartz crystal microgravimetry study of metal deposition from EDTA complexes.” J. Electrochem. Soc., 147(3), 1088 (2000).
31. L. Ding, F. Liu, J. Cheng, and Y. Niu, “Effects of four N-based additives on imitation gold plating.” J. Appl. Electrochem., 48(2), 175 (2018).
32. L. L. Barbosa, M. R. H. de Almeida, R. M. Carlos, M. Yonashiro, G. M. Oliveira, and I. A. Carlos, “Study and development of an alkaline bath for copper deposition containing sorbitol as complexing agent and morphological characterization of the copper film.” Surf. Coat. Technol., 192(2-3), 145 (2005).
33. Z. J. Barton, and J. Rodriguez-López, “Lithium ion quantification using mercury amalgams as in situ electrochemical probes in nonaqueous media.” Anal. Chem., 86(21), 10660 (2014).
34. Z. J. Barton and J. Rodríguez-López, “Fabrication and demonstration of mercury disc-well probes for stripping-based cyclic voltammetry scanning electrochemical microscopy.” Anal. Chem., 89(5), 2716 (2017).
35. M. Saravanan, M. Ganesan, and S. Ambalavanan, “An in situ generated carbon as integrated conductive additive for hierarchical negative plate of lead-acid battery.” J. Power Sources, 251, 20 (2014).
36. A. J. Bard, F. R. F. Fan, J. Kwak, O. Lev, “Scanning electrochemical microscopy. Introduction and principles.” Anal. Chem., 61(2), 132 (1989).
37. J. Kwak, and A. J. Bard, “Scanning electrochemical microscopy. Theory of the feedback mode.” Anal. Chem., 61(11), 1221 (1989).
38. A. B. Nepomnyashchii, M. A. Alpuche-Aviles, S. Pan, D. Zhan, F. R. F. Fan, and A. J. Bard, “Cyclic voltammetry studies of Cd²⁺ and Zn²⁺ complexation with hydroxyl-terminated polyamidoamine generation 2 dendrimer at a mercury microelectrode.” J. Electroanal. Chem., 621(2), 286 (2008).
39. M. A. Baldo, S. Daniele, and G. A. Mazzocchin, “Cyclic voltammetry at mercury microelectrodes. Effects of mercury thickness and scan rate.” Electrochim. Acta, 41(6), 811 (1996).
40. J. Mauzeroll, E. A. Hueske, and A. J. Bard, “Scanning electrochemical microscopy. 48. Hg/Pt hemispherical ultramicroelectrodes: fabrication and characterization.” Anal. Chem., 75(15), 3880 (2003).
41. R. S. Juang, S. W. Wang, and L. C. Lin, “Simultaneous recovery of EDTA and lead (II) from their chelated solutions using a cation exchange membrane.” J. Membr. Sci., 160(2), 225 (1999).
42. K. R. Wehmeyer and R. M. Wightman, “Cyclic voltammetry and anodic stripping voltammetry with mercury ultramicroelectrodes.” Anal. Chem., 57(9), 1989 (1985).
43. Z. T. Gossage, J. Hui, Y. Zeng, H. Flores-Zuleta, and J. Rodríguez-López, “Probing the reversibility and kinetics of Li⁺ during SEI formation and (de) intercalation on edge plane graphite using ion-sensitive scanning electrochemical microscopy.” Chem. Sci., 10(46), 10749 (2019).
44. Z. J. Barton, J. Hui, N. B. Schorr, and J. Rodríguez-López, “Detecting Potassium Ion Gradients at a Model Graphitic Interface.” Electrochim. Acta, 241, 98 (2017).
45. J. Hui, M. Burgess, J. Zhang, and J. Rodriguez-Lopez, “Layer number dependence of Li⁺ intercalation on few-layer graphene and electrochemical imaging of its solid-electrolyte interphase evolution.” ACS Nano, 10(4), 4248 (2016).
46. S. Daniele, M. A. Baldo, P. Ugo, and G. A. Mazzocchin, “Determination of heavy metals in real samples by anodic stripping voltammetry with mercury microelectrodes: Part 2. Application to Rain and Sea Waters.” Anal. Chim. Acta, 219, 19 (1989).
47. M. A. Alpuche-Aviles, J. E. Baur, and D. O. Wipf, “Imaging of Metal Ion Dissolution and Electrodeposition by Anodic Stripping Voltammetry-Scanning Electrochemical Microscopy.” Anal. Chem. 80(10), 3612 (2008).
48. H. P. Wu, “Dynamics and performance of fast linear scan anodic stripping voltammetry of Cd, Pb, and Cu using in situ-generated ultrathin mercury films.” Anal. Chem., 68(9), 1639 (1996).
49. J. Wang, and B. Tian, “Gold ultramicroelectrodes for on-site monitoring of trace lead.” Electroanalysis, 5(9-10), 809 (1993).
50. Y. Bonfil, M. Brand, and E. Kirowa-Eisner, “Characteristics of subtractive anodic stripping voltammetry of Pb and Cd at silver and gold electrodes.” Anal. Chim. Acta, 464(1), 99 (2002).
51. S. M. Wong and L. M. Abrantes, “Lead electrodeposition from very alkaline media.” Electrochim. Acta, 51 (4), 619 (2005).
52. S. Cherevko, X. Xing, and C. H. Chung, “Hydrogen template assisted electrodeposition of sub-micrometer wires composing honeycomb-like porous Pb films.” Appl. Surf. Sci., 257 (18), 8054 (2011).
53. L. Muresan, L. Oniciu, M. Froment, and G. Maurin, “Inhibition of lead electrocrystallization by organic additives.” Electrochim. Acta, 37 (12), 2249 (1992).
54. A. Liu, Z. Shi, and R. G. Reddy, “Electrodeposition of Pb from PbO in urea and 1-butyl-3-methylimidazolium chloride deep eutectic solutions.” Electrochim. Acta, 251, 176 (2017).
55. N. D. Nikolić, G. Branković, and U. Č. Lačnjevac, “Formation of two-dimensional (2D) lead dendrites by application of different regimes of electrolysis.” J. Solid State Electr., 16 (6), 2121 (2012).
56. I. A. Carlos, T. T. Matsuo, J. L. P. Siqueira, and M. R. H. de Almeida, “Voltammetric and morphological study of lead electrodeposition on copper substrate for application of a lead-acid batteries.” J. Power Sources, 132, 261 (2004).
57. L. A. Yolshina, V. Y. Kudyakov, and V. G. Zyryanov, “Development of an electrode for lead-acid batteries possessing a high electrochemical utilization factor and invariable cycling characteristics.” J. Power Sources, 65, 71 (1997).
58. I. A. Carlos, M. A. Malaquias, M. M. Oizumi, and T. T. Matsuo, “Study of the influence of glycerol on the cathodic process of lead electrodeposition and on its morphology.” J. Power Sources, 92, 56 (2001).
59. A. J. Bard and L. R. Faulkner, Fundamentals and applications. Electrochemical methods, John Wiley & Sons: New York, (2001).
60. Zhao, Y. et al., Sustain. Chem. 2021, 2, 167-205
61. Tian, X. et al., J. Clean. Prod. 2017, 144 142-148
62. Ballantyne, A. D., et. al., R. Soc. open sci. 2018, 5: 171368
63. United States Environmental Protection Agency. 1994 Secondary Lead Smelting Background Information Document for Proposed Standards
64. Li, M. et. al., Waste Manag. Res. 2016, 34(4) 298-306
65. Zhang, W., et. al., Renew. Sust. Energ. Rev. 2016, 61, 108-122
66. Morachevskii, A., et. al., Russ. J. Appl. Chem. 1996, 69, 412-14.
67. Andrews, D. J. Power Sources 2000, 88, 124-29.
68. Volpe, M., et. al., Hydrometallurgy 2009, 96, 123-31.
69. Wu, Z., et. al., Hydrometallurgy 2014, 142, 23-35.
70. Pan, J. et. al., Nat Commun, 2013, 4, 2178.
71. Qiu, D. et al., Inorg. Chem. Ind. 2014, 46, 16-19
72. Ellis, T. W., et. al., J. Power Sources 2010, 195, 4525-29.
73. Z. Gossage, F Guo, K Hatfield, T Martin, Q Tian, E Gao, A Kumar, J Rodriguez-Lopez, and H Zhao, “Reconstruction of Lead Acid Battery Negative Electrodes after Hard Sulfation Using Controlled Chelation Chemistry.” J. Electrochem. Soc., 167 120537 (2020),

All of the patents, patent applications, patent application publications and other publications recited herein are hereby incorporated by reference as if set forth in their entirety, including those found in the “References” section above.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

### List of Embodiments

The following is non-limiting list of embodiments of the invention:
1. A method for removing sulfate from a battery electrode, comprising:
   placing the battery electrode in a chelate solution to solubilize the sulfate and remove sulfate deposits from the battery electrode, wherein the soaking results in a chelate-metal solution;
   performing electrodeposition of a metal film on the battery electrode, the electrodeposition comprising electrolysis of the chelate-metal solution.
2. The method of any one of embodiments 1, wherein the battery electrode comprises Pb and the sulfate comprises a hard sulfate, and placing the battery electrode in a solution comprises soaking the battery electrode in an alkaline EDTA solution to reshape a surface of the electrode by solubilizing PbSO₄ to Pb-EDTA while avoiding underlying Pb phases.
3. The method of embodiment 1 wherein the battery electrode comprises Pb and the sulfate comprises a hard sulfate, and placing the battery electrode in a solution comprises soaking the battery electrode in an ammonium salt solution to reshape the surface of the electrode by solubilizing PbSO₄ while avoiding underlying Pb phases.
4. The method of any one of embodiments 1-2, wherein the chelator solution comprises EDTA.
5. The method of embodiments 1 or 3, wherein the chelate solution comprises of ammonium carbonate.
6. The method of embodiments 1 or 3, wherein the chelate solution comprises of ammonium phosphate.
7. The method of embodiments 1, 3, 5-6, wherein the chelate solution comprises the ammonium salt of a weak acid.
8. The methods of embodiments 1, 3, 5-7, wherein the battery is treated with a strong acid solution.
9. The method of embodiments 1, 3, 5-8, wherein the battery is treated with H₂SO₄ solution.
10. The methods of embodiments 1, 3, 5-9, wherein the battery is treated with HNO₃ solution.
11. The methods of embodiments 1, 3, 5-10, wherein the battery is treated with a weak acid solution.
12. The method of any one of embodiments 1-11, wherein the sulfate comprises hard sulfate.
13. The method of any one of embodiments 1-11 wherein the hard sulfate comprises PbSO₄ crystals having a size in the range of 20-100
14. The method of any one of embodiments 1-11, wherein the chelator solution has a pH greater than or equal to 3.
15. The method of any one of embodiments 1-11, wherein the chelator solution has a pH greater than or equal to 8.
16. The method of any one of embodiments 1-11, wherein the chelator solution has a pH less than or equal to 10.
17. The method of any one of embodiments 1-11, wherein the chelator solution has a pH greater than or equal to 3 and less than or equal to 10.
18. The method of any one of embodiments 1-17, wherein:
   the chelate solution has a formation constant K, and a level of protonation impacts chelation to other ions in solution through the conditional K, or K′ as described by:

K′=α_{Y}⁴⁻K
where α represents the fraction of the chelator in one of the protonated forms, and Yⁿ⁻ designates the charge and form with n number of unprotonated groups.
19. The method of embodiment 18, further comprising adjusting K′ to adjust the speed of sulfate removal.
20. The method of embodiment 18, wherein a chelator of the chelator solution has a high K′.
21. The method of any one of embodiments 18-20, further comprising adjusting the pH of the chelator solution.
22. The method of embodiments 18-21, wherein adjusting the pH of the chelator solution comprises adjusting the pH of the chelator solution to adjust the speed of sulfate removal.
23. The method of any one of embodiments 1-18, further comprising, after soaking the battery electrode, washing the battery electrode in DI water.
24. The method of any one of embodiments 1-18, wherein placing the battery electrode in a chelate solution comprises soaking the battery electrode in the chelate solution for at least 12 hours.
25. The method of any one of embodiments 1-25, wherein the performing electrodeposition of a metal film on the battery electrode comprises growth of the metal film through electrolysis of chelate-metal and reusing chelate molecules for further chelation reactions.
26. The method of any one of embodiments 1-25, wherein the performing electrodeposition of a metal film on the battery electrode comprises growth of the metal film through electrolysis of chelate-metal and reusing chelate molecules for further chelation reactions.
27. A battery refurbished by the method of any one of embodiments 1-26.
28. A product comprising any feature described, either individually or in combination with any feature, in any configuration.
29. A method comprising any method described, in any order using any modality.
30. The invention substantially as disclosed herein.

We claim:

1. A method for removing sulfate from a battery electrode, comprising:
placing the battery electrode in a chelate solution to solubilize the sulfate and remove sulfate deposits from the battery electrode, and
performing electrodeposition of a metal film on the battery electrode,
wherein placing the battery electrode in a chelate solution involves soaking and the soaking results in a chelate-metal solution;
wherein the electrodeposition comprising electrolysis of the chelate-metal solution.

2. The method of claim 1, wherein the battery electrode comprises lead (Pb) and the sulfate comprises a hard sulfate, and placing the battery electrode in a solution comprises soaking the battery electrode in an alkaline EDTA solution to reshape a surface of the electrode by solubilizing PbSO₄ to Pb-EDTA while avoiding underlying Pb phases.

3. The method of claim 1, wherein the battery electrode comprises lead (Pb) and the sulfate comprises a hard sulfate, and placing the battery electrode in a solution comprises soaking the battery electrode in an ammonium salt solution to reshape the surface of the electrode by solubilizing PbSO₄ while avoiding underlying Pb phases.

4. The method of claim 1, wherein the chelator solution comprises EDTA.

5. The method of claim 1, wherein the chelator solution comprises of ammonium carbonate.

6. The method of claim 1, wherein the chelator solution comprises of ammonium phosphate.

7. The method of claim 1, wherein the chelate solution comprises the ammonium salt of a weak acid.

8. The methods of claim 1, wherein the battery is treated with a strong acid or a weak acid solution.

9. The method of claim 1, wherein the battery is treated with H₂SO₄ or HNO₃ solution.

10. The method of claim 1, wherein the sulfate comprises hard sulfate.

11. The method of claim 1, wherein the hard sulfate comprises PbSO₄ crystals having a size in the range of about 20-100 μm.

12. The method of claim 1, wherein the chelator solution has a pH greater than or equal to 3.

13. The method of claim 1, wherein the chelator solution has a pH greater than or equal to 8.

14. The method of claim 1, wherein the chelator solution has a pH less than or equal to 10.

15. The method of claim 1, wherein the chelator solution has a pH greater than or equal to 3 and less than or equal to 10.

16. The method of claim 1, further comprising after soaking the battery electrode, washing the battery electrode in water.

17. The method of claim 1, wherein placing the battery electrode in a chelate solution comprises soaking the battery electrode in the chelate solution for at least 12 hours.

18. The method of claim 1, wherein the performing electrodeposition of a metal film on the battery electrode comprises growth of the metal film through electrolysis of chelate-metal and reusing chelate molecules for further chelation reactions.

19. The method of claim 1, wherein the performing electrodeposition of a metal film on the battery electrode comprises growth of the metal film through electrolysis of chelate-metal and reusing chelate molecules for further chelation reactions.

20. A battery refurbished by the method of claim 1.
